(19) United States
(12) Patent Application Publication
(10) Pub. No.: US 2007/0237417 A1
(43) Pub. Date: Oct. 11, 2007

(54) Method and apparatus for determining camera focal length

(76) Inventor: Motilal Agrawal, Mountain View, CA (US)

Correspondence Address: PATTERSON & SHERIDAN, LLP;SRI INTERNATIONAL, 595 SHREWSBURY AVENUE, SUITE 100, SHREWSBURY, NJ, 07702, US

(21) Appl. No.: 11/250,243

(22) Filed: Oct. 14, 2005

Related U.S. Application Data
(60) Provisional application No. 60/618,689, filed on Oct. 14, 2004.

(51) Int. Cl. G06K 9/40

(52) U.S. Cl. 382/255

(57) ABSTRACT

A method and apparatus are provided for determining or estimating the focal length of a camera based on a series of images captured by the camera. In one embodiment, a method for determining focal length includes obtaining a plurality of images of a three-dimensional scene from the camera, matching feature points across a subset of the images, deriving a projective reconstruction from the feature point matching, and finally recovering a metric reconstruction from the projective reconstruction in accordance with semidefinite programming. Once the metric reconstruction is recovered, the camera's intrinsic parameters, including focal length, can be estimated.

### CROSS REFERENCE TO RELATED APPLICATIONS

This application claims the benefit of U.S. Provisional Patent Application Ser. No. 60/618,689, filed Oct. 14, 2004, which is herein incorporated by reference in its entirety.

### REFERENCE TO GOVERNMENT FUNDING

This invention was made with Government support under contract number DAAD19-01-2-0012, awarded by the U.S. Army. The Government has certain rights in this invention.

### FIELD OF THE INVENTION

The present invention relates generally to computer vision and relates more specifically to determining the focal length of a moving camera.

### BACKGROUND OF THE DISCLOSURE

Reconstruction of three-dimensional (3D) scenes from a video sequence is a fundamental problem of computer vision. One way in which this objective can be advanced is advancing the state of the art in uncalibrated structure from motion.

Currently, the best result achievable in the uncalibrated setting is a reconstruction of a scene up to an unknown projective transformation. This projective structure, however, is insufficient for many applications which require measurement of three-dimensional angles or distances, thereby necessitating a metric or Euclidean reconstruction (e.g., as in the case of a camera placed inside a vehicle to determine the location of a passenger). To obtain the Euclidean reconstruction, though, knowledge of the camera's calibration parameters (e.g., focal length, aspect ratio) is needed. Typically, these parameters are obtained offline using a calibration pattern. However, this approach is quite restrictive.

Thus, there is a need in the art for a method and apparatus for determining camera focal length.

### SUMMARY OF THE INVENTION

A method and apparatus are provided for determining or estimating the focal length of a camera based on a series of images captured by the camera. In one embodiment, a method for determining focal length includes obtaining a plurality of images of a three-dimensional scene from the camera, matching feature points across a subset of the images, deriving a projective reconstruction from the feature point matching, and finally recovering a metric reconstruction from the projective reconstruction in accordance with semidefinite programming. Once the metric reconstruction is recovered, the camera's intrinsic parameters, including focal length, can be estimated.

### BRIEF DESCRIPTION OF THE DRAWINGS

The teachings of the present invention can be readily understood by considering the following detailed description in conjunction with the accompanying drawings, in which:

FIG. 1 is a flow diagram illustrating one embodiment of a method for determining camera focal length, according to the present invention;

FIG. 2 is a flow diagram illustrating one embodiment of a method for obtaining a metric reconstruction from a projective reconstruction using semidefinite programming, according to the present invention; and

FIG. 3 is a high level block diagram of the present method for focal length determination that is implemented using a general purpose computing device.

To facilitate understanding, identical reference numerals have been used, where possible, to designate identical elements that are common to the figures.

### DETAILED DESCRIPTION

In one embodiment, the present invention relates to a method and apparatus for determining camera focal length through application of semidefinite programming (SDP). In one embodiment, the present invention assumes that the camera has rectangular pixels (e.g., is a skewless camera) and that the principal point of the camera is known and fixed. The present invention then estimates the aspect ratio and focal length of the camera at each frame of a video sequence in accordance with these assumptions.

As used herein, the term “camera” refers to any image capturing device that is capable of capturing still and/or moving images (e.g., a photo camera, a video camera, a cell phone camera, etc.).

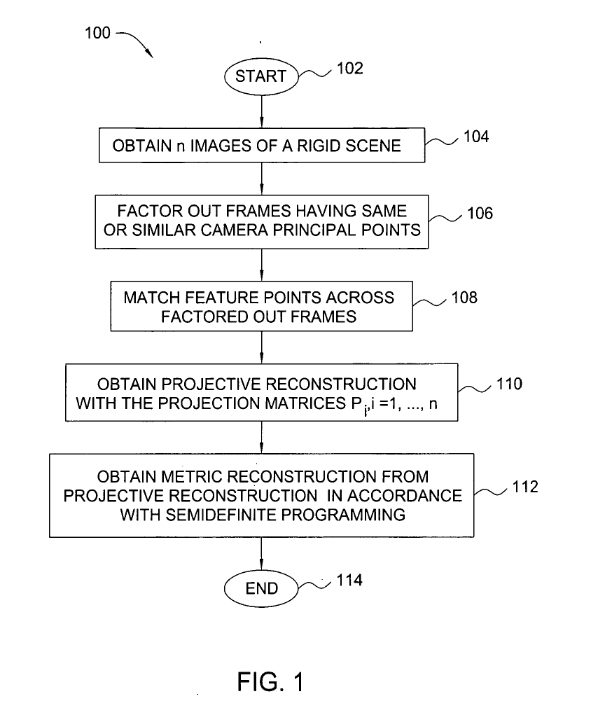

FIG. 1 is a flow diagram illustrating one embodiment of a method 100 for determining camera focal length, according to the present invention. In this embodiment, the principal point position of the camera is assumed to be fixed at the center of an image or sequence of images.

The method 100 is initialized at step 102 and proceeds to step 104, where the method 100 obtains n images of a rigid scene. In one embodiment, n is at least three. In one embodiment, the n images are received from a camera having changing intrinsic and/or extrinsic parameters. Intrinsic parameters, denoted as Kⁱ, are those parameters that can be varied by varying the camera's focal length, while extrinsic parameters are those parameters that can be varied by moving the camera itself. In one embodiment, the camera is a skewless camera (e.g., having rectangular pixels). In further embodiments, the intrinsic parameters are assumed to be constant. In such embodiments, the camera's focal length and aspect ratio are unknown and remain to be estimated.

In step 106, the method 100 factors out frames or images having the same or similar principal points. Typically, frames or images that are close in time will have similar principal points. Hence, in some embodiments, the method 100 may be applied to each batch of N consecutive frames.

In step 108, the method 100 matches feature points across the frames that were factored out in step 104. Feature points are distinctive points in an image, and the selection of feature points is influenced by this measure of distinctiveness. For example, corner points in a scene are distinctive and may thus function as feature points. In order to match these feature points across a number of frames, an image similarity measure is used (e.g., the feature points will look similar across all of the frames).

Once feature points have been matched across the frames, the method 100 proceeds to step 110 and obtains a projective reconstruction with projection matrices Pⁱ, i=1, . . . , n. In one embodiment, the projective reconstruction is obtained in accordance with an iterative factorization algorithm, such as that described by S. Mahamud and M, Herbert in “Iterative Projective Reconstruction from Multiple Views”, Proc. IEEE Computer Vision and Pattern Recognition Conference, vol. II, 2000).

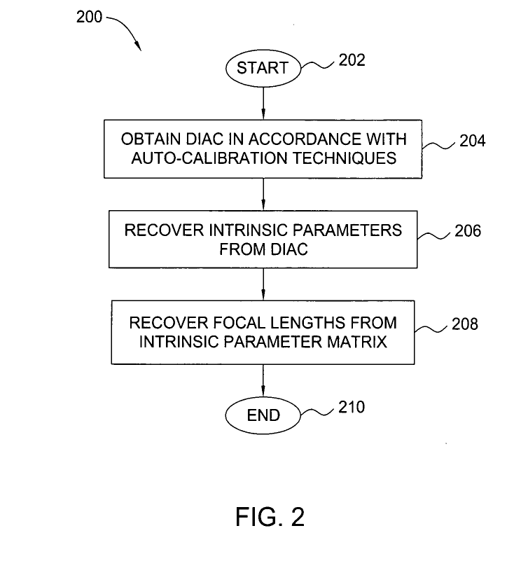

In step 112, the method 100 obtains a metric (or Euclidean) reconstruction from the projective reconstruction in accordance with semidefinite programming (e.g., an extension of linear programming in which non-negativity constraints are replaced by positive semidefinite constraints on matrix variables). Specifically, the method 100 applies a semidefinite programming framework to formulate an auto-calibration problem that recovers camera parameters (e.g., focal length, apect ratio, etc.) using rigidity constraints present in the 3D scene and certain simplifying assumptions. The metric reconstruction will yield the focal lengths (in pixels), αₓⁱ and α_{y}ⁱ, of each camera in the x and y directions, respectively. One embodiment of a method for applying semidefinite programming to obtain the metric reconstruction is discussed in further detail with respect to FIG. 2. The method 100 then terminates in step 114.

The application of semidefinite programming to the auto-calibration problem overcomes many drawbacks inherent in conventional techniques that attempt to solve using linear algorithms. For example, some known linear least squares (LLS) approaches do not enforce certain constraints or conditions that are necessary to ensure substantial accuracy of the solution. Experimental results have shown that the focal length estimates produced by the present invention, applying the semidefinite programming framework, are more accurate (e.g., produced lower rates of error) than those produced by applying a linear programming framework. Moreover, the present invention can, using the semidefinite programming framework, incorporate a large number of views more easily than conventional methods can.

FIG. 2 is a flow diagram illustrating one embodiment of a method 200 for obtaining a metric reconstruction from a projective reconstruction using semidefinite programming, according to the present invention. In particular, the method 200 formulates an auto-calibration problem as a constrained norm minimization problem and solves in accordance with semidefinite programming to obtain a corresponding metric reconstruction.

The method 200 is initialized in step 202 and proceeds to step 204, where the method 200 obtains the DIAC, Ω*ⁱ, associated with the camera in accordance with auto-calibration techniques. The DIAC, Ω*ⁱ, is the dual of the absolute conic (IAC), which is a calibration object that is always present but can only be observed through constraints on the intrinsic parameters, Kⁱ, of the camera.

The basic projection equation for a camera with a projection matrix of Pⁱ=[Aⁱ aⁱ] may be given as:
xⱼ−PⁱXⱼ (EQN. 1)
where Xⱼ is the homogeneous coordinate of a 3D point, xⱼ is the projection of the 3D point in the image of the 3D scene, and Aⁱ and aⁱ contain the intrinsic and extrinsic camera parameters, respectively. The projection matrix Pⁱ contains information about the pose of the camera and its intrinsic parameters, Kⁱ, represented by the matrix:

$${K}^{i} = [ \begin{matrix}{α}_{x} & s & {x}_{0} \\ 0 & {α}_{y} & {y}_{0} \\ 0 & 0 & 1\end{matrix} ] \qquad ( EQN . 2 )$$

where, as stated above, αₓ and α_{y} are the camera's focal lengths (in pixels) in the x and y directions, respectively; s is the camera skew; and x₀ and y₀ are the principal points of the camera.

As discussed above, the absolute conic is an imaginary conic closely tied to the intrinsic parameters, Kᵢ, of the camera. The absolute conic's dual, Ω*ⁱ (the DIAC), is represented by:
Ω*ⁱ=KⁱK^{it} (EQN. 3)
where K^{it} is the transpose of Kⁱ. The matrix Ω*ⁱ is symmetric and positive semidefinite (denoted as Ω*ⁱ≧0). If the skew of the camera is zero (s=0), then the DIAC, Ω*ⁱ, can be written compactly as:

$$\begin{matrix}{ω}^{* i} = {F}_{0} + {α}_{x}^{2} {F}_{1} + {α}_{y}^{2} {F}_{2} \\ where & ( EQN . 4 ) \\ {F}_{0} = [ \begin{matrix}{x}_{0}^{2} & {x}_{0} {y}_{0} & {x}_{0} \\ {x}_{0} {y}_{0} & {y}_{0}^{2} & {y}_{0} \\ {x}_{0} & {y}_{0} & 1\end{matrix} ] & ( EQN . 5 ) \\ {F}_{1} = [ \begin{matrix}1 & 0 & 0 \\ 0 & 0 & 0 \\ 0 & 0 & 0\end{matrix} ] \\ and & ( EQN . 6 ) \\ {F}_{2} = [ \begin{matrix}0 & 0 & 0 \\ 0 & 1 & 0 \\ 0 & 0 & 0\end{matrix} ] & ( EQN . 7 )\end{matrix}$$

The goal of auto-calibration is to recover the DIAC, Ω*ⁱ, by exploiting the rigidity constraints present in the 3D scene depicted in the image(s).

In one embodiment, the DIAC, Ω*ⁱ may be solved for simultaneously with the plane at infinity, π∞, by equivalent formulation using the absolute quadric, Q_{∞}, an imaginary degenerate quadric represented by a 4×4 matrix of rank three. Given n cameras, the unknown parameters (the DIAC, Ω*ⁱ and the plane at infinity, π∞ may be related to the known entries of the projection matrices Pⁱ, i=1, . . . , n according to the basic equation for auto-calibration for the i^{th} image:

$$\begin{matrix}{κ}^{i} {ω}^{* i} = ( {A}^{i} - {a}^{i} {π}_{∞}^{t} ) {{ω}^{* 1} ( {A}^{i} - {a}^{i} {π}_{∞}^{t} )}^{T} = {P}^{i} {Q}_{∞}^{*} {P}^{i T} \\ i = 2 , … , n \\ and & ( EQN . 8 ) \\ {Q}_{∞}^{t} = [ \begin{matrix}{ω}^{* i} & - {ω}^{* i} {π}_{∞} \\ - {π}_{∞} {ω}^{* i} & {π}_{∞} {ω}^{* 1} {π}_{∞}\end{matrix} ] & ( EQN . 9 )\end{matrix}$$

where κⁱ is an unknown scale factor. Since Ω*ⁱ is positive semidefinite (Ω*ⁱ≧0), it is easy to ascertain that the right-hand side (RHS) of the equation is semidefinite positive and κⁱ≧0. In accordance with the equation above, constraints on the scale factor, κⁱ, are translated into constraints on the DIAC, Ω*ⁱ, which in turn gives an equation relating Ω*ⁱ and π∞. Given enough such constraints, it is possible to solve for the unknown parameters (the DIAC, Ω*ⁱ, and the plane at infinity, π∞).

For example, for a skewless camera (s=0) having a known principal point (x₀, y₀), the constraints become linear and can be solved for using linear least squares (LLS).

Substituting the expression for Ω*ⁱ given by EQN. 4 into the basic equation for auto-calibration for the i^{th} image (EQN. 8) yields:
κⁱ(F₀+αₓⁱ²F₁+α_{y}ⁱ²F₂)=(Aⁱ−aⁱπ_{∞}^{t}(F₀+αₓ²F₁+α_{y}²F₂)(Aⁱ−aⁱπ_{∞}^{t})^{T} (EQN. 10)

In one embodiment, π_{∞}^{t}=(n₁, n₂, n₃) and e₁, e₂, e₃ are the three standard basis vectors for the group of 3×3 matrices (i.e., e₁^{t}=(1 0 0), etc.). If γ₇ⁱ=κⁱ, γ₈ⁱ=κⁱαₓⁱ² and γ₉ⁱ=κⁱα_{y}ⁱ², then the left-hand side (LHS) of EQN. 8 can be written as:

$${LHS}^{i} = {\sum }_{j = 0}^{2} {γ}_{7 + j}^{i} {F}_{j} \qquad ( EQN . 11 )$$

After multiplying the terms, the right-hand side (RHS) of EQN. 8 can be written as an affine combination of seven symmetric matrices, G₀ⁱ, . . . , G₆ⁱ, as follows:
AⁱF₀A^{iT}+αₓ²AⁱF₁A^{iT}+α_{y}²AⁱF₂A^{iT}+RHSⁱ=αₓ²n₁(Aⁱe₁a^{iT}+aⁱe₁^{T}A^{iT})+α_{y}²n₁(Aⁱe₂a^{iT}+aⁱe₂^{T}A^{iT})+n₃(Aⁱe₃a^{iT}+aⁱe₃^{T}A^{iT})+(n₃²+aₓ²n₁²+a_{y}²n₂²)aⁱa^{iT} (EQN. 12)

Let γ₁=αₓ², γ₂=α_{y}², γ₃=αₓ²n₁, γ₄=α_{y}²n₂, γ₅=n₃ and γ₆=n₃²+αₓ²n₁²+α_{y}²n₂². Then, the expression above (EQN. 12) becomes:

$${RHS}^{i} = {G}_{0}^{i} + {\sum }_{j = 1}^{6} {γ}_{j} {G}_{j}^{i} \qquad ( EQN . 13 )$$

The auto-calibration problem can thus be cast as a minimization of the sum of the norm of n−1 matrices, subject to certain semidefinite programming constraints, as:

$$minimize {\sum }_{i = 2}^{n} ‖ {LHS}^{i} - {RHS}^{i} ‖ \qquad ( EQN . 14 )$$

Because of the parameterization being used, the rank constraint for the absolute quadric Q*_{∞} is automatically enforced. It is also relatively simple to add the constraint that the DIAC, Ω*ⁱ, is positive semidefinite, such that EQN. 14 is subject to the following:
F₀+γ₁F₁+γ₂F₂≧0 (EQN. 15)
γ₇ⁱF₀+γ₈ⁱF₁+γ₉ⁱF₂0i=2, . . . , n (EQN. 16)

The expressions for γ₁, γ₂ and γ₆ imply that these variables are non-negative. Similarly, γ₇ⁱ, γ₈ⁱ and γ₉ⁱ are also non-negative. Thus, the constraints of EQNS. 15 and 16 can be replaced by:
diag(γ₁, γ₂, γ₆, γ₇², . . . , γ₇ⁿ, γ₈², . . . , γ₈², γ₉ⁿ)≧0 (EQN. 17)
which is a block diagonal matrix with diagonal entries γ₁, γ₂, γ₆, γ₇², γ₇ⁿ, γ₈², . . . , γ₈ⁿ, γ₉², . . . , γ₉ⁿ.

Applying these constraints in conjunction with the norm minimization of the sum yields a constrained norm minimization problem in which the variables are γ₁, . . . , γ₆, γ₇, γ₈ⁱ, γ₉ⁱ for i=2, . . . , n and the semidefinite programming (SDP) constraints in the norm minimization problem correspond to the equations above (i.e., EQNS. 15, 16 and 17). Therefore, the problem becomes a standard norm minimization problem that can be solved using a standard SDP solver to obtain the variables γ₁, . . . , γ₆, γ₇ⁱ, γ₈ⁱ, γ₉ⁱ. In one embodiment, the problem is solved in accordance with a C library of routines for semidefinite programming (CSDP).

Referring back to FIG. 2, once the DIAC, Ω*ⁱ, has been obtained, the method 200 recovers the intrinsic parameters, Kⁱ, of the camera from the DIAC, Ω*ⁱ in step 206. In one embodiment, the intrinsic parameters, Kⁱ, are obtained from the DIAC by Cholesky factorization, thereby updating the projective structure to a metric structure.

In step 208, the method 200 then recovers the focal lengths αₓ and α_{y} from the intrinsic parameters matrix, Kⁱ. The variables γ₁, . . . , γ₆, γ₇ⁱ, γ₈ⁱ, γ₉ⁱ are directly related to focal length (as indicated by the expressions given above for the variables), and thus the focal lengths αₓ and α_{y} can be obtained once these variables are known. For example, αₓ=\sqrt{γ₁} and α_{y}=\sqrt{γ₂}. In addition, the aspect ratio is recovered as αₓ/α_{y}.

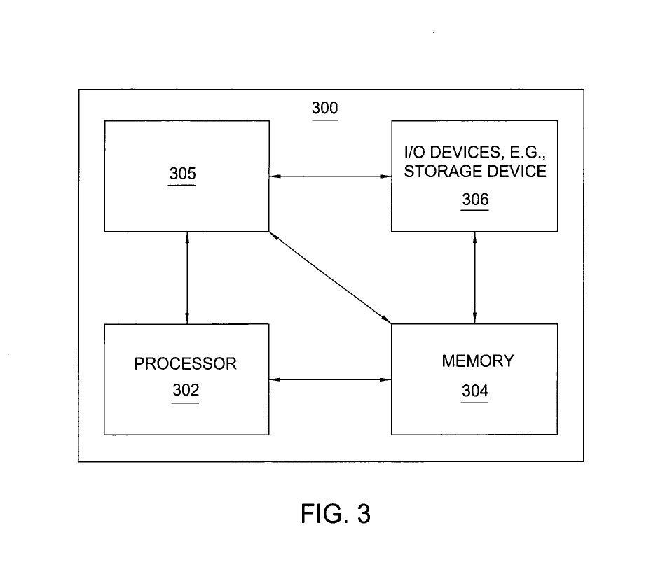

FIG. 3 is a high level block diagram of the present method for focal length determination that is implemented using a general purpose computing device 300. In one embodiment, a general purpose computing device 300 comprises a processor 302, a memory 304, a focal length determination module 305 and various input/output (I/O) devices 306 such as a display, a keyboard, a mouse, a modem, and the like. In one embodiment, at least one I/O device is a storage device (e.g., a disk drive, an optical disk drive, a floppy disk drive). It should be understood that the focal length determination module 305 can be implemented as a physical device or subsystem that is coupled to a processor through a communication channel.

Alternatively, the focal length determination module 305 can be represented by one or more software applications (or even a combination of software and hardware, e.g., using Application Specific Integrated Circuits (ASIC)), where the software is loaded from a storage medium (e.g., I/O devices 306) and operated by the processor 302 in the memory 304 of the general purpose computing device 300. Thus, in one embodiment, the focal length determination module 305 for determining camera focal length described herein with reference to the preceding Figures can be stored on a computer readable medium or carrier (e.g., RAM, magnetic or optical drive or diskette, and the like).

Thus, the present invention represents a significant advancement in the field of computer vision. The present invention provides improved focal length estimates (e.g., having lower rates of error) compared to those produced by applying conventional methods for recovering focal length. Moreover, the present invention can, using the semidefinite programming framework, incorporate a large number of views more easily than conventional methods can.

Although various embodiments which incorporate the teachings of the present invention have been shown and described in detail herein, those skilled in the art can readily devise many other varied embodiments that still incorporate these teachings.

What is claimed is:

1. A method for determining a focal length of a camera, comprising:
obtaining a plurality of images of a three-dimensional scene from said camera;
matching one or more feature points across at least a subset of said plurality of images;
deriving a projective reconstruction from said matching; and
recovering a metric reconstruction from said projective reconstruction in accordance with semidefinite programming.

2. The method of claim 1, wherein said projective reconstruction is derived in accordance an iterative factorization technique.

3. The method of claim 1, further comprising:
recovering an intrinsic parameter matrix for said camera from said metric reconstruction; and
recovering said focal length from said intrinsic parameter matrix.

4. The method of claim 1, wherein said recovering comprises:
formulating an auto-calibration problem as a constrained norm minimization problem; and
solving said constrained norm minimization problem using a semidefinite programming solver.

5. The method of claim 4, wherein said constrained norm minimization problem applies one or more rigidity constraints present in said three-dimensional scene.

6. The method of claim 1, wherein said at least a subset of said plurality of images comprises images sharing similar camera parameters.

7. The method of claim 6, wherein said camera parameters include at least one of: an extrinsic parameter or an intrinsic parameter.

8. The method of claim 1, wherein said camera is assumed to be a skewless camera.

9. The method of claim 1, wherein a principal point of said camera is assumed to be known and fixed.

10. The method of claim 1, wherein intrinsic parameters of said camera are assumed to be constant.

11. A computer readable medium containing an executable program for determining a focal length of a camera, the method comprising:
obtaining a plurality of images of a three-dimensional scene from said camera;
matching one or more feature points across at least a subset of said plurality of images;
deriving a projective reconstruction from said matching; and
recovering a metric reconstruction from said projective reconstruction in accordance with semidefinite programming.

12. The computer readable medium of claim 11, wherein said projective reconstruction is derived in accordance an iterative factorization technique.

13. The computer readable medium of claim 11, further comprising:
recovering an intrinsic parameter matrix for said camera from said metric reconstruction; and
recovering said focal length from said intrinsic parameter matrix.

14. The computer readable medium of claim 11, wherein said recovering comprises:
formulating an auto-calibration problem as a constrained norm minimization problem; and
solving said constrained norm minimization problem using a semidefinite programming solver.

15. The computer readable medium of claim 14, wherein said constrained norm minimization problem applies one or more rigidity constraints present in said three-dimensional scene.

16. The computer readable medium of claim 11, wherein said at least a subset of said plurality of images comprises images sharing similar camera parameters.

17. The computer readable medium of claim 16, wherein said camera parameters include at least one of: an extrinsic parameter or an intrinsic parameter.

18. The computer readable medium of claim 11, wherein said camera is assumed to be a skewless camera.

19. The computer readable medium of claim 11, wherein a principal point of said camera is assumed to be known and fixed.

20. The computer readable medium of claim 11, wherein intrinsic parameters of said camera are assumed to be constant.

21. Apparatus for determining a focal length of a camera, the apparatus comprising:
means for obtaining a plurality of images of a three-dimensional scene from said camera;
means for matching one or more feature points across at least a subset of said plurality of images;
means for deriving a projective reconstruction from said matching; and
means for recovering a metric reconstruction from said projective reconstruction in accordance with semidefinite programming.
